(19) United States
(12) Patent Application Publication
(10) Pub. No.: US 2025/0214323 A1
(43) Pub. Date: Jul. 3, 2025

(54) COMPOSITE PANE HAVING A HOLOGRAM ELEMENT AND AN OPTICALLY HIGHLY-REFRACTIVE LAYER

(71) Applicant: SAINT-GOBAIN GLASS FRANCE, COURBEVOIE (FR)

(72) Inventors: Oliver GIER, HERZOGENRATH (DE); Jan HAGEN, HERZOGENRATH (DE); Andreas GOMER, HERZOGENRATH (DE)

(21) Appl. No.: 18/876,522

(22) PCT Filed: Jun. 13, 2023
(86) PCT No.: PCT/EP2023/065777

§ 371 Date: Dec. 18, 2024

(30) Foreign Application Priority Data
Jun. 21, 2022 (EP) 22180027.9

(51) Int. Cl. B32B 17/10; C03C 17/22; C03C 17/245

(52) U.S. Cl. CPC B32B 17/10357; B32B 17/10036; B32B 2255/20; B32B 2307/418; B32B 2605/00; C03C 17/225; C03C 17/245; C03C 2218/156

(57) ABSTRACT

A composite pane includes an outer pane having an outer surface and an interior surface, an inner pane having an outer surface and an interior surface, a first intermediate layer, and a hologram element having at least one hologram, wherein the first intermediate layer is arranged between the outer pane and the inner pane, the hologram element is arranged between the outer pane and the first intermediate layer or between the inner pane and the first intermediate layer, and wherein an optically highly-refractive layer is arranged on the interior surface of the inner pane.

The invention relates to a composite pane having a hologram element and an optically highly-refractive coating, a method for producing such a composite pane, and the use of such a composite pane.

Composite panes are nowadays used in many places, and in particular in vehicle construction. In this context, the term, “vehicle,” includes road vehicles, aircraft, ships, agricultural machinery, or even work equipment.

Composite panes are also used in other areas. These include, for example, building glazing or information displays, e.g., in museums or as advertising displays.

Composite panes are frequently also used as head-up displays (HUD) to display information. In this case, an image is projected onto the composite glass panes by means of an imaging unit in order to display information in the viewer's field of view. In the vehicle sector, the imaging unit is arranged, for example, on the dashboard, such that the projected image is reflected in the direction of the viewer on the nearest glass surface of the composite glass pane that is inclined towards the viewer (cf., for example, European patent EP 0 420 228 B1 or German patent application DE 10 2012 211 729 A1).

Head-up displays in which the projected image is reflected in the direction of the viewer on the nearest glass surface of the composite glass pane that is inclined towards the viewer are subject to the law of reflection, according to which the angle of incidence and the angle of reflection are equal. The angle of inclination of the composite glass pane thus cannot be freely selected.

Hologram elements laminated between the panes of a composite pane can also be used for head-up displays. The hologram element has at least one hologram, and the hologram can contain information recorded therein. The hologram can be activated by means of light emitted by a projector, thus reproducing the information recorded in the hologram for the viewer. Head-up displays based upon the principle of holography—so-called holographic head-up displays—are disclosed, for example, in publications WO 2012/156124 A1, US 2019/0056596 A1, U.S. Pat. No. 10,394,032 B2, U.S. Pat. No. 10,061,069 B2, and US 2015/205138 A1.

DE 10 2020 112 447 A1 discloses a method for integrating a hologram into a rigid component of a predetermined surface target geometry using a hologram-receiving layer of a liquid photopolymer.

A hologram can be produced in a holographic material, i.e., a photosensitive material, which is laminated between the panes of a composite pane. To record a hologram, two, mutually-coherent light beams—the so-called reference beam—which can also be referred to as a reference wave, and the so-called object beam, which can also be referred to as an object wave, are directed onto a holographic material. The resulting interference pattern of the superimposed wave fronts is written to the holographic material as an alternating refractive index modulation. If the reference wave and the object wave have parallel wavefronts, the interference pattern corresponds to a parallel grating whose lamellae are angled below the angle bisector of reference wave and object wave. After recording, the holographic material is cured, thereby losing the ability to record further holograms. If the holographic material in which the hologram was recorded is again irradiated with the reference wave, the light at the recorded grating of the hologram is diffracted such that the diffracted wave corresponds to the object wave. By illuminating the interference pattern written into the holographic material with the reference wave, the object wave can thus be reconstructed.

Head-up displays in which the projected image is reproduced by means of a hologram in the direction of the viewer thus make it possible to produce composite panes with laminated holograms, in which the angle of incidence on the composite pane is not as large as the angle of reflection. Consequently, the angle of inclination of the composite pane can be selected more freely for holographic head-up displays.

It is advantageous when producing a composite pane with a hologram to record the hologram in the holographic material of a hologram element precursor only after the lamination process, since the lamination process can have a negative effect upon the optical properties of a recorded hologram. A method for producing a laminated holographic display in which the hologram is recorded only after lamination is disclosed, for example, in EP 3 461 636 B1.

However, recording a hologram in the holographic material of a hologram element precursor laminated between two glass panes is problematic, because any change in the refractive index causes reflections of the object beam and the reference beam when the hologram is being recorded. Thus, undesirable reflections on the surfaces of the two glass panes facing away from the holographic material lead to undesirable interference patterns, and thus to undesirable gratings recorded in the holographic material. These undesirable, recorded gratings result in the hologram showing undesirable artifacts when irradiated with the reference wave after the holographic material has cured. In addition, the undesirable gratings recorded in the hologram can be activated from the outside by external light sources. This leads to unnecessary distractions and possibly glare for the viewer, and should therefore be minimized for safety reasons.

In the context of the present application, the term, “hologram element precursor,” means the precursor of a hologram element. A hologram element precursor does not have a hologram. By recording at least one hologram by exposing the holographic material of a hologram element precursor to an object beam and a reference beam, a hologram element is obtained. The hologram element obtained differs from the hologram element precursor in that at least one hologram is recorded in the hologram element.

In WO 2021/087286 A1, a replication tool for use in producing a holographic film by replication is disclosed, and a method for producing composite glazing using the replication tool is disclosed. During replication, an oil or gel having a matching refractive index may be arranged in a cavity between the laminated glazing and the main holographic film arrangement to reduce reflections during replication and improve the quality of the composite glazing.

US 2019/101865 A1 discloses a method for producing a laminated holographic display, wherein a display precursor is first provided. The display precursor comprises a first glass layer, a second glass layer, an unexposed photopolymer film layer arranged between the first glass layer and the second glass layer, and a polymer layer arranged between the second glass layer and the unexposed photopolymer film layer.

WO 2022/053404 A1 discloses a method for producing a composite pane with a hologram, wherein a photosensitive material is applied as a hologram element in a coating area on the surface of a first pane, a hologram is formed in the hologram element by selective laser irradiation, and the first pane with a hologram is laminated with a second pane to form the composite pane.

WO 2021/209201 A1 discloses a projection arrangement for a head-up display (HUD) comprising a composite pane with HUD area and an HUD projector emitting p-polarized radiation. The composite pane comprises an outer pane and an inner pane joined together via an intermediate layer, wherein a highly-refractive sol-gel coating having a refractive index of at least 1.7 is applied to the surface, facing away from the intermediate layer, of the inner pane.

EP 0536763 B1 discloses a composite pane, integrated into a projection arrangement, comprising a hologram, wherein a light beam emitted from a light source passes through a liquid crystal panel, the information displayed on the liquid crystal panel is projected onto a mirror, and the information is reflected by said mirror onto the composite pane with the hologram. The light beam incident on the hologram is diffracted and reflected by the pattern of the hologram element, wherein the light beam resulting from the diffraction exits the hologram element, strikes a film of a windshield and is reflected by the latter in the direction of the driver, and is perceived as an image. The hologram is thus not embedded in the windshield itself, but in an additional pane mounted in the vehicle interior.

Whereas, in head-up displays, in which the projected image is reproduced by means of a hologram in the direction of the viewer, a reflection of the reference wave on the outer surface of the outer pane is attenuated as a result of diffraction at the recorded grating of the hologram; in particular, a reflection of the reference wave on the interior surface of the inner pane can appear as a weak but nevertheless interfering ghost image. If the light emitted by a projector and incident upon the composite pane at the Brewster (incidence) angle is exclusively p-polarized, the reflected portion of the light at the Brewster angle is close to zero. The Brewster angle is determined by the difference in the refractive indices between two media. The refractive index of a conventional composite pane with a holographic medium is approximately 1.5. If the external medium is air, as is usually the case, with a refractive index of 1, the Brewster angle is approximately 56°. If a minimum reflection, i.e., an incidence of light as close as possible to the Brewster angle, is to be achieved, the degree of freedom of the arrangement of a projector, e.g., relative to the projection surface, i.e., for example, a windshield with an HUD function, is therefore significantly restricted.

The object of the present invention is to provide—in particular, for a head-up display—an improved composite pane with a hologram element, in which the angle of inclination of the composite pane can be selected more freely, and in particular shifted to larger angles of inclination, while maintaining good image quality, and, at the same time, the occurrence of undesirable ghost images and artifacts of the composite pane is minimized. In addition, it shall be possible to produce the composite pane simply and inexpensively, even in an industrial series production.

The object of the present invention is achieved by a composite pane according to independent claim 1. Preferred embodiments are apparent from the dependent claims. A method for producing a composite pane according to the invention and the use thereof are apparent from further independent claims.

The invention relates to a composite pane at least comprising an outer pane having an outer surface and an interior surface, an inner pane having an outer surface and an interior surface, a first intermediate layer, and a hologram element having at least one hologram.

The composite pane is a vehicle pane, i.e., it is suitable for being installed in a vehicle, and when installed, the vehicle pane separates the vehicle interior from the surroundings.

The outer pane, also referred to as the first pane, constitutes pane of the composite pane, which pane is adjacent to the vehicle surroundings when installed. The outer pane has an exterior surface, also referred to as side I, facing towards and adjacent to the vehicle surroundings. The pane surface of the outer pane opposite the exterior surface of the outer pane is referred to as the interior surface, also called side II, of the outer pane and faces the interior of the vehicle when the glazing is installed. The inner pane, also referred to as the second pane, constitutes the pane of the composite pane facing the vehicle interior when installed in a vehicle. The inner pane has an exterior surface, also referred to as side III, facing the outer pane and the vehicle surroundings when installed. The pane surface of the inner pane opposite the exterior surface of the inner pane is referred to as the interior surface of the inner pane, also called side IV, and is adjacent to the vehicle interior when installed.

The first intermediate layer is arranged between the outer pane and the inner pane, and the hologram element is arranged between the outer pane and the first intermediate layer or between the inner pane and the first intermediate layer. The first intermediate layer, as well as optionally existing further intermediate layers, join the first pane and the second pane together.

According to the invention, exactly one optically highly-refractive, and preferably transparent, layer is arranged on the interior surface of the inner pane (side IV). In the sense of the invention, “preferably transparent” means that the optically highly-refractive layer is preferably permeable to light in the visible range of the light spectrum from 380 nm to 780 nm. Particularly preferably, the optically highly-refractive layer has a transmission of at least 70% in the visible range of the light spectrum. This optically highly-refractive layer advantageously makes it possible to select the angle of inclination of the composite pane in a projection arrangement more freely, and in particular to shift it towards larger Brewster angles. This means that artifacts and ghost images caused by reflected components of the light can be avoided as far as possible, even when the composite pane is installed in steeper positions, as is the case in trucks or tractors, for example.

The optically highly-refractive layer is also referred to below as the HI layer or HI coating, wherein HI stands for the term, “high index,” i.e., highly refractive. According to the invention, it is provided that exactly one HI layer be applied directly to the interior surface (inner side/side IV) of the inner pane. This is imperative at least in the area of the composite pane which is intended to serve as a projection surface in a projection arrangement. Thus, the HI layer forms the outer surface, facing the interior, of the composite pane according to the invention.

According to the invention, the optically highly-refractive layer (HI layer) has a refractive index greater than or equal to 2.

In the context of the present invention, refractive indices are generally given relative to a wavelength of 550 nm. The refractive index can be determined, for example, by ellipsometry. Ellipsometers are commercially available—for example, from Sentech. The refractive index of a dielectric layer is preferably determined by first depositing it as a single layer on a substrate and subsequently measuring the refractive index by ellipsometry. To determine the refractive index of a dielectric layer sequence, the layers of the layer sequence are each deposited alone as individual layers on a substrate, and then the refractive index is determined by ellipsometry. According to the invention, a refractive index of at least 2 must be achieved for each of these individual layers. Dielectric layers with a refractive index of at least 2 and methods for deposition thereof are known to the person skilled in the art in the field of thin films. Preferably, methods of physical vapor deposition, and in particular magnetron sputtering, are used.

The composite pane is a vehicle pane. Thus, the hologram element is directly integrated into the vehicle glazing, and no further composite panes with a hologram are required in the beam path of the projector of a projection arrangement. The composite pane is preferably a windshield into which the hologram element is directly integrated.

In a preferred embodiment, the HI coating on the interior surface of the inner pane is formed on the basis of silicon nitride, tin-zinc oxide, silicon-zirconium nitride, silicon-titanium nitride, silicon-hafnium nitride, or titanium oxide, and particularly preferably on the basis of silicon-zirconium nitride or titanium oxide (TiOx). These materials have proven to be particularly advantageous for increasing the Brewster angle.

The optically highly-refractive layer having a refractive index greater than or equal to 2 is formed as a coating, and preferably on the basis of silicon nitride, zinc-tin oxide, silicon-zirconium nitride, or titanium oxide (TiOx).

The phrase, “formed on the basis of . . . ,” means, according to the invention, that the HI coating consists of or substantially consists of the aforementioned material, in addition to possibly conventional impurities or dopants. According to the invention, more than 95 wt %, and preferably more than 97 wt %, e.g., 98 wt %, of the HI layer is formed from this material. The aforementioned materials of the HI layer can be undoped or, for example, doped with transition metal oxides such as ZnO, ZrO₂, and HfOx.

In one design of the invention, the optically highly-refractive layer is formed with a layer thickness of 10 nm to 100 nm, preferably of 20 nm to 80 nm, and particularly preferably of 50 nm to 70 nm.

The outer pane and the inner pane each have an exterior surface, i.e., an outer surface, and an interior surface, i.e., an inner surface, and a circumferential side edge extending therebetween. For the purposes of the invention, the term, “external surface,” refers to the main surface which, when installed, is intended to face the external surroundings. For the purposes of the invention, the term, “interior surface,” refers to the main surface which, when installed, is intended to face the interior. The interior surface of the outer pane and the exterior surface of the inner pane face one another in the composite pane according to the invention.

The surfaces of the glass panes are typically referred to as follows:

The exterior surface of the outer pane is referred to as side I. The interior surface of the outer pane is referred to as side II. The exterior surface of the interior pane is referred to as side III. The interior surface of the inner pane is referred to as side IV.

The composite pane is provided for separating an interior in a window opening of a vehicle from the external surroundings, wherein the term, “interior pane,” for the purposes of the invention, refers to the pane facing the interior (vehicle interior). The outer pane refers to the pane facing the external surroundings.

The hologram element refers to the holographic medium in which the hologram is contained. The hologram element comprises a photosensitive material, i.e., a holographic material. A hologram can be recorded therein by exposure to a suitable light source. In the finished composite pane, the material of the hologram element is no longer light-sensitive, because the holographic material is changed during the process to such an extent that no further recording of a hologram is possible.

The hologram element comprises a holographic material and can, additionally, optionally comprise a first substrate layer and/or a second substrate layer. Suitable holographic materials are known to the person skilled in the art. Suitable first and second substrate layers are likewise known to the person skilled in the art.

Preferably, the hologram element comprises a photopolymer, dichromate gelatin, or silver halide gelatin, and particularly preferably a photopolymer, as the holographic material.

Silver halides or dichromates are typically used in a matrix of gelatin, which is first usually dried at room temperature before a hologram can be recorded by exposure to light.

In a first preferred embodiment, the holographic material is formed as a coating on the interior surface of the outer pane or as a coating on the outer surface of the inner pane.

The composite pane can additionally comprise a second intermediate layer. In a second preferred embodiment of the composite pane according to the invention, the hologram element is arranged between the first intermediate layer and the inner pane, and an additional second intermediate layer is arranged between the inner pane and the hologram element.

In a preferred embodiment, the hologram element comprises a holographic material, a first substrate layer, and a second substrate layer, wherein the holographic material is arranged between the first intermediate layer and the inner pane, a second intermediate layer is arranged between the holographic material and the inner pane, the first substrate layer is arranged between the holographic material and the first intermediate layer, and the second substrate layer is arranged between the holographic material and the second intermediate layer. The holographic material is consequently arranged in this embodiment between a first substrate layer and a second substrate layer.

In a further embodiment, the hologram element comprises a first substrate layer and a holographic material.

In this embodiment too, the composite pane can optionally comprise a second intermediate layer. When a second intermediate layer is present, this is arranged between the inner pane and the hologram element, and the first intermediate layer is arranged between the outer pane and the hologram element.

The intermediate layers can, independently of one another, be a thermoplastic intermediate layer, an adhesive layer, or an optically clear adhesive.

The first intermediate layer is preferably a thermoplastic intermediate layer, an adhesive layer, or an optically clear adhesive (OCA).

The second intermediate layer is preferably a thermoplastic intermediate layer, an adhesive layer, or an optically clear adhesive (OCA).

An optically clear adhesive (OCA) is characterized by high light transmission, low turbidity, no double refraction, high UV resistance, and good aging resistance. Uncontrolled and therefore undesirable impairment of light transmission or unaesthetic distortions can thus be avoided.

The adhesive layer preferably has an absorption in the visible spectral range of less than 5%, and in particular less than 2% or even 1%, and preferably a turbidity of less than 5%, and in particular less than 2% or even less than 1%.

The adhesive layer is preferably formed as a homogeneous layer.

The adhesive layer preferably has a thickness of 20 μm to 200 μm, particularly preferably of 50 μm to 150 μm, and very particularly preferably of 60 μm to 100 μm. Good optical properties are thus achieved. In addition, adhesive layers with these thicknesses are commercially available as adhesive films. Alternatively, the adhesive of the adhesive layer can also be used as a liquid adhesive.

The adhesive of the adhesive layer is preferably a chemically-active—in particular, chemically-curing—adhesive or UV-curing, and particularly preferably an acrylate adhesive or a silicone-based adhesive.

The first substrate layer contains, for example, polyamide (PA), polycarbonate (PC), cellulose triacetate (TAC), and/or polyethylene terephthalate (PET). The first substrate layer is, for example, 35 μm (micrometers) to 60 μm thick.

The second substrate layer contains, for example, polyamide (PA), polycarbonate (PC) cellulose triacetate (TAC), and/or polyethylene terephthalate (PET). The second substrate layer is, for example, 35 μm (micrometers) to 60 μm thick.

The materials mentioned for the substrate layer are suitable for advantageously reducing, or preventing, the diffusion of plasticizers.

As described above, in a preferred embodiment, the holographic material comprises a photopolymer. The photopolymer is, for example, 10 μm to 100 μm, e.g., 16 μm, thick. Suitable photopolymers are known to the person skilled in the art. The photopolymer preferably comprises crosslinked polyurethane (PU). Alternatively, a liquid photopolymer can also be used.

In one embodiment, a UV protective layer is arranged between the outer pane and the holographic material in the composite pane according to the invention. Such a UV protective layer prevents aging processes of the holograms recorded in the holographic material which are caused by UV radiation from the outside.

The outer pane and the inner pane are made of glass, and particularly preferably soda-lime glass, as is customary for window panes. However, the outer pane and the inner pane can also be made of other types of glass, e.g., fused silica, borosilicate glass, or alumino-silicate glass, or of rigid clear plastics, e.g., polycarbonate or polymethyl methacrylate. The outer pane and inner pane may, independently of one another, be clear, or also tinted or colored. Composite panes designed as windshields must have sufficient light transmission in the central viewing area—preferably at least 70% in the main viewing area A in accordance with ECE-R43. The outer pane and the inner pane are preferably bent, i.e., they have a curvature.

The outer pane and/or the outer side (side III) of the inner pane can have suitable coatings known per se, e.g., non-stick coatings, anti-scratch coatings on the outer side of the outer pane, heatable coatings, anti-sun coatings, or low-E coatings.

Preferably, a first intermediate layer or second intermediate layer formed as a thermoplastic intermediate layer contains or consists of at least polyvinyl butyral (PVB), ethylene vinyl acetate (EVA), polyurethane (PU), or copolymers or derivatives thereof, more preferably polyvinyl butyral (PVB), and most preferably polyvinyl butyral (PVB) and additives known to the person skilled in the art, such as plasticizers.

Preferably, a first intermediate layer or second intermediate layer formed as a thermoplastic intermediate layer contains at least 60 wt %, particularly preferably at least 70 wt %, in particular at least 90 wt %, and, for example, at least 97 wt %, polyvinyl butyral.

A first intermediate layer formed as a thermoplastic intermediate layer can be formed by a single film or also by more than one film.

A second intermediate layer formed as a thermoplastic intermediate layer can likewise be formed by a single film or also by more than one film.

The first intermediate layer and, if present, the second intermediate layer can also, independently of one another, be a functional intermediate layer, and in particular an intermediate layer with acoustic damping properties, an infrared radiation-reflecting intermediate layer, an infrared radiation-absorbing intermediate layer, a UV radiation-absorbing intermediate layer, an at least partially colored intermediate layer, and/or an at least partially tinted intermediate layer. Thus, the first intermediate layer and, if present, the second intermediate layer can, independently of one another, also be a bandpass filter film, for example.

The thickness of a first intermediate layer or second intermediate layer formed as a thermoplastic intermediate layer is between 30 μm and 1,500 μm, preferably between 50 μm and 780 μm, and preferably 350 μm and 760 μm, and is, for example, 380 μm or 760 μm.

The hologram element preferably has a thickness of 5 μm to 500 μm, preferably of 10 μm to 200 μm, and particularly preferably of 15 μm to 150 μm.

The thickness of the outer pane and the inner pane can vary widely, and thus be adapted to the requirements in individual cases. The outer pane and the inner pane preferably have thicknesses of 0.5 mm to 5 mm, and particularly preferably of 1 mm to 3 mm.

The composite pane according to the invention can comprise one or more additional intermediate layers, and in particular functional intermediate layers. An additional intermediate layer can in particular be an intermediate layer with acoustic damping properties, an infrared radiation-reflecting intermediate layer, an infrared radiation-absorbing intermediate layer, an at least partially colored intermediate layer, and/or an at least partially tinted intermediate layer. When several additional intermediate layers are present, they can also have different functions.

A composite pane according to the invention may additionally comprise a cover print—in particular of a dark, and preferably black, enamel. The cover print is in particular a peripheral, i.e., frame-like, cover print. The peripheral cover print primarily serves as UV protection for the mounting adhesive of the composite pane. The cover print can be opaque and cover the entire area. The cover print can also be semi-transparent at least in sections—for example, as a dot screen, striped screen, or checkered screen. Alternatively, the cover print can also have a gradient—for example, from an opaque covering to a semi-transparent covering.

The hologram element preferably does not extend to the pane edge, while the first intermediate layer extends to the pane edge. In this embodiment, the hologram element in the composite pane is sealed at its circumferential edge by the first intermediate layer or further layers arranged there, and thus protected from external influences such as moisture and cleaning agents. In addition, diffusion of plasticizers from the hologram element can be reduced or avoided.

Preferably, if the hologram element is not arranged over the entire area of the pane, a barrier film with a cutout is arranged in a frame-like manner around the hologram element. The cutout corresponds to the area in which the hologram element is arranged. The hologram element is arranged within this cutout and completely fills it. The barrier film is in the form of a circumferential frame and is in direct contact with the circumferential edge of the hologram element. The hologram element and the barrier film thus lie in the same plane and contact one another along their edges, wherein their contact faces are substantially orthogonal to the pane surfaces of the composite pane. In the composite pane according to the invention, the barrier film in the form of a circumferential frame compensates for a local difference in thickness between the area with the hologram element and the surrounding area. According to the invention, the barrier film does not overlap with the hologram element, but is merely applied in its immediate vicinity adjacent to the circumferential edge of the hologram element, thus enabling this compensation for differences in thickness. Accordingly, the composite pane with a hologram element not only has improved aging resistance, but also improved durability due to minimization of stresses as well as glass breakage.

The barrier film is preferably a polymer layer and preferably contains or consists substantially of polyvinyl butyral (PVB), polyethylene terephthalate (PET), polyamide (PA), polyethylene (PE), polymethyl methacrylate (PMMA), polycarbonate (PC), polyvinyl chloride (PVC), and cellulose triacetate (TAC).

The composite pane according to the invention is preferably bent in one or more directions in space, as is customary for motor vehicle windows, wherein typical radii of curvature are in the range of about 10 cm to about 40 m. However, the laminated glass may also be planar—for example, if it is provided as a pane for buses, trains, or tractors.

A composite pane according to the invention has a top edge and a bottom edge, as well as two side edges extending between the top edge and the bottom edge. The top edge refers to the edge which is intended to point upwards in the installed position. The bottom edge refers to the edge which is intended to point downwards in the installed position. The top edge is often also referred to as the roof edge and the bottom edge as the engine edge.

Composite panes designed as windshields have a central field of view on whose optical quality high demands are placed. The central field of view must have high light transmission (typically greater than 70%). The said central field of view is in particular that field of view which is referred to by the person skilled in the art as field of view B, viewing range B, or zone B. The field of view B and its technical requirements are defined in Regulation No. 43 of the Economic Commission of the United Nations for Europe (UN/ECE) (ECE-R43, “Uniform provisions concerning the approval of safety glazing materials and their installation on vehicles”). The field of view B is defined therein in Appendix 18.

The hologram element is advantageously arranged within the central field of view (field of view B) in a composite pane designed as a windshield. The hologram element can, but need not, cover the entire area, and can also project beyond it. The hologram element preferably extends over at least 30%, particularly preferably over at least 50%, and, further, more preferably over at least 80%, of the pane. As a result, visible transitions between the hologram element and a section without hologram element in the visible area of the pane can be avoided. Particularly preferably, the hologram element is arranged such that the circumferential edge of the hologram element is arranged in the area of an opaque cover print. This has the advantage that the opaque cover print hides the transition from the hologram element to the surrounding layer. The cover print is usually located in the edge area of the pane and hides the view of mounting parts or adhesives. Windshields typically have a surrounding peripheral cover print made of an opaque enamel, which in particular serves to protect the adhesive used to install the windshield from UV radiation and to hide it visually. This peripheral cover print is preferably used to also cover the circumferential edge of the hologram element. Preferably, both the outer pane and the inner pane of the composite pane have a cover print, such that visibility in the edge area is obstructed from both sides.

The hologram element can also have recesses or holes—for example, in the area of so-called sensor windows or camera windows. These areas are intended to be equipped with sensors or cameras whose function could be impaired by a hologram element in the beam path.

The hologram element is preferably arranged over the entire width and the entire height of the composite pane, and particularly preferably minus a circumferential edge area with a width of, for example, 5 mm to 50 mm. The hologram element is thus protected from contact with the surrounding atmosphere and corrosion. The width of the circumferential edge area can be constant or can vary.

The composite pane can, for example, be the windshield or roof panel of a vehicle or other vehicle glazing—for example, in a motor vehicle, rail vehicle, or bus.

The invention also comprises a projection arrangement for presenting information to a viewer, at least comprising a composite pane according to the invention and a projector which is directed from inside, i.e., from a vehicle interior, onto the hologram element on the side IV. The composite pane according to the invention can be formed as described above in the various embodiments.

The projector of the projection arrangement emits light with wavelengths to which the hologram, or, if there is more than one hologram, the holograms of the hologram element respond.

In the projection arrangement according to the invention, undesirable reflection of the light emitted by the projector on the interior surface of the inner pane of the composite pane is minimized by the HI coating. Advantageously, the Brewster angle at which the reflected component of the light is minimized—in particular, close to zero for p-polarized light—can be shifted towards higher angles and selected more freely.

The invention also relates to a method for producing a composite pane, wherein at least:
a) an outer pane having an outer surface and an interior surface, a first intermediate layer, a hologram element having at least one hologram and an inner pane having an outer surface and an interior surface, and an HI coating applied to the interior surface are provided,
b) a layer stack is formed in which the first intermediate layer is arranged between the outer pane and the inner pane, and the hologram element is arranged between the outer pane and the first intermediate layer or between the inner pane and the first intermediate layer,
c) the layer stack is joined by lamination.

The hologram element can contain, for example, dichromate gelatin or silver halide gelatin or a photopolymer as the holographic material, as described above.

In the embodiment of the method according to the invention described above, the optically highly-refractive layer is applied to the interior surface of the inner pane before lamination.

Alternatively, it is also possible to apply the optically highly-refractive coating to the interior surface of the inner pane (side IV) only after lamination, such that, in step a), an uncoated inner pane is initially provided.

Also according to the invention is thus a method for producing a composite pane, wherein at least:
a) an outer pane having an outer surface and an interior surface, a first intermediate layer, a hologram element having at least one hologram and an inner pane having an outer surface and an interior surface are provided,
b) a layer stack is formed in which the first intermediate layer is arranged between the outer pane and the inner pane, and the hologram element is arranged between the outer pane and the first intermediate layer or between the inner pane and the first intermediate layer,
c) the layer stack is joined by lamination,
d) an optically highly-refractive layer is applied to the interior surface of the inner pane.

The optically highly-refractive layer can be applied to the interior surface of the inner pane by established methods such as wet coating, magnetron sputtering, or chemical (CVD) or physical vapor deposition (PVD).

Advantageously, such a coating can be incorporated into the industrial series production of composite panes without difficulty and at low cost.

It is understood that, in step a), instead of a hologram element in which at least one hologram is recorded, an unexposed hologram element precursor made of light-sensitive material can alternatively be provided in each case. Thus, the formation of the layer stack can also take place in step b), and the lamination with the unexposed hologram element precursor or with the final hologram element with recorded hologram element can take place in step c). It is understood that, when the unexposed hologram element precursor is provided in step a), a method according to the invention comprises recording at least one hologram in the hologram element precursor as an additional step after the lamination of the layer stack.

The layer stack is preferably laminated under the action of heat, vacuum, and/or pressure. Methods known per se for lamination can be used—for example, autoclave methods, vacuum bag methods, vacuum ring methods, calendering methods, vacuum laminators, or combinations thereof.

If the composite pane is to be bent, the outer pane and the inner pane are preferably subjected to a bending process before lamination. Preferably, the outer pane and the inner pane are jointly bent congruently (i.e., at the same time and by the same tool), because this optimally matches the shape of the panes for the subsequent lamination. Typical temperatures for glass bending processes are, for example, 500° C. to 700° C.

Any opaque cover prints, i.e., in particular, circumferential black prints in the edge area of the pane, are preferably applied by screen printing.

In one design, a cover print in the edge area of the composite pane can also be provided on the inner side of the inner pane. This cover print can also advantageously conceal the view from an interior of mounting parts, lines, or adhesive bonds and thus contribute to the composite pane having a more visually appealing appearance and also improve adhesive bonds or protect them from UV light. The cover print can be applied directly to the inside of the inner pane. In this case, no HI coating is, in this edge area, applied to the side IV. Alternatively, however, the cover print in the edge area can also be formed on the HI coating, such that the HI layer covers substantially the entire interior surface of the inner pane.

The embodiments described above in connection with the composite pane according to the invention also apply in the same way to the method according to the invention, and vice versa.

The invention further comprises the use of a composite pane according to the invention having at least one hologram as a vehicle pane in locomotion means for traffic on land, in the air, or on water—in particular, in motor vehicles and in particular as a windshield serving as a projection surface for a head-up display.

The invention will be explained in more detail with reference to drawings and exemplary embodiments. The drawings are schematic representations and are not true-to-scale. The drawings do not limit the invention in any way.

In the drawings:

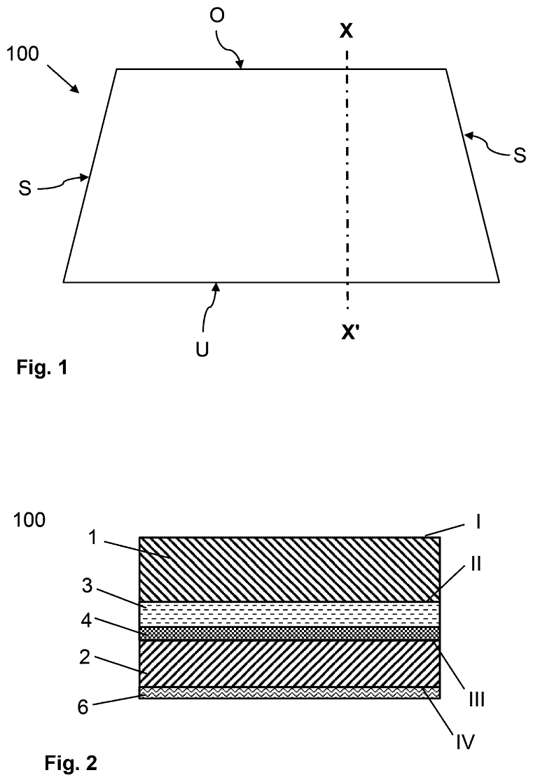

FIG. 1 shows a plan view of a design of a composite pane 100 according to the invention,

FIG. 2 shows a cross-section through the design of a composite pane 100 according to the invention shown in FIG. 1;

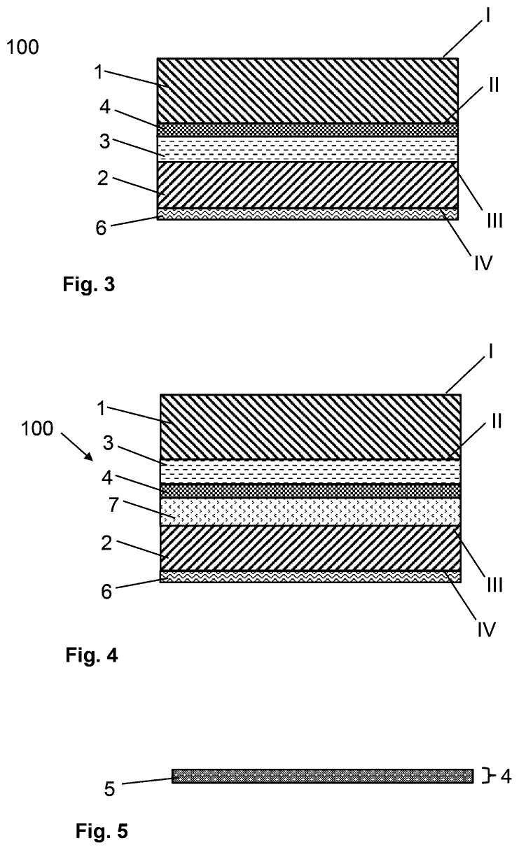

FIG. 3 shows a cross-section through a further design of a composite pane 100 according to the invention,

FIG. 4 shows a cross-section through a further design of a composite pane 100 according to the invention,

FIG. 5 shows a cross-section of an embodiment of a hologram element,

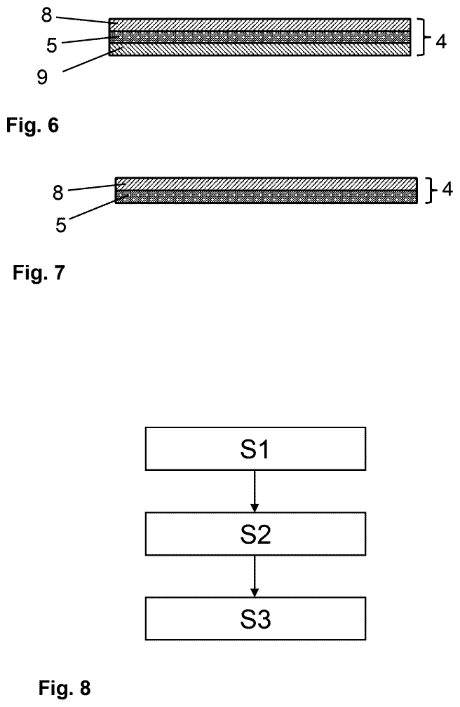

FIG. 6 shows a cross-section of a further embodiment of a hologram element,

FIG. 7 shows a cross-section of a further embodiment of a hologram element, and

FIG. 8 shows an exemplary embodiment of a method according to the invention using a flowchart.

FIG. 1 shows a plan view of a design of a composite pane 100 according to the invention, and FIG. 2 shows the cross-section through the design of a composite pane 100 according to the invention shown in FIG. 1 along the line section X-X′. In the embodiment shown in FIG. 1, the composite pane 100 has a top edge O, a bottom edge U, and two side edges S.

As illustrated in FIG. 2, the composite pane 100 comprises an outer pane 1 having an exterior surface I and an interior surface II, a first intermediate layer 3, a hologram element 4, an inner pane 2 having an exterior surface III and an interior surface IV, and an HI coating 6. In the embodiment shown in FIGS. 1 and 2, the hologram element 4 is arranged over the entire area between the outer pane 1 and the inner pane 2, the first intermediate layer 3 is arranged over the entire area between the outer pane 1 and the hologram element 4, and the HI coating 6 is arranged over the entire the interior surface IV of the inner pane 2. According to the invention, the HI coating 6 is preferably formed on the basis of silicon nitride, tin-zinc oxide, silicon-zirconium nitride, silicon-titanium nitride, silicon-hafnium nitride, or titanium oxide, and particularly preferably on the basis of silicon-zirconium nitride or titanium oxide (TiOx). The HI layer 6 is formed, for example, with a layer thickness of 20 nm to 80 nm, and particularly preferably of 50 nm to 70 nm.

The outer pane 1 consists, for example, of soda-lime glass and is 2.1 mm thick. The inner pane 2 consists, for example, of soda lime-glass and is 1.6 mm thick. In the embodiment shown in FIGS. 1 and 2, the first intermediate layer 3 is, for example, a thermoplastic intermediate layer, consists, for example, of polyvinyl butyral (PVB), and is 0.76 mm thick.

In the embodiment shown in FIGS. 1 and 2, the hologram element 4 is formed, for example, as shown in FIG. 5 or 7. If the hologram element 4 is formed as illustrated in FIG. 7, the hologram element 4 is preferably arranged such that the first substrate layer 8 is arranged directly adjacent to the first intermediate layer 3.

FIG. 3 shows a cross-section of a further design of a composite pane 100 according to the invention. The composite pane 100 shown in cross-section in FIG. 3 differs from that shown in FIG. 2 only in that the first intermediate layer 3 is arranged between the inner pane 2 and the hologram element 4.

In the embodiment shown in FIG. 3, the hologram element 4 is formed, for example, as shown in FIG. 5 or 7. If the hologram element 4 is formed as illustrated in FIG. 7, the hologram element 4 is preferably arranged such that the first substrate layer 8 is arranged directly adjacent to the first intermediate layer 3.

FIG. 4 shows a cross-section of a further design of a composite pane 100 according to the invention. The composite pane 100 shown in cross-section in FIG. 4 differs from that shown in FIG. 2 in that a second intermediate layer 7 is arranged between the hologram element 4 and the inner pane 2. The second intermediate layer 7 is, for example, a thermoplastic intermediate layer and consists, for example, of polyvinyl butyral (PVB) and is 0.76 mm thick.

In the embodiment shown in FIG. 4, the hologram element 4 is formed, for example, as shown in FIG. 5, 6, or 7.

FIG. 5 shows a cross-section of an embodiment of a hologram element 4. In the embodiment shown in FIG. 5, the hologram element 4 consists of a holographic material 5. The holographic material 5 is, for example, a photopolymer, dichromate gelatin, or silver halide gelatin.

FIG. 6 shows a cross-section of a further embodiment of a hologram element 4. In the embodiment shown in FIG. 6, the hologram element 4 comprises a first substrate layer 8, a second substrate layer 9, and a holographic material 5 arranged in-between. The holographic material 5 is, for example, a photopolymer, dichromate gelatin, or silver halide gelatin.

FIG. 7 shows a cross-section of a further embodiment of a hologram element 4. In the embodiment shown in FIG. 7, the hologram element 4 comprises a first substrate layer 8 and a holographic material 5. The holographic material 5 is, for example, a photopolymer, dichromate gelatin, or silver halide gelatin.

FIG. 8 shows an exemplary embodiment of the method according to the invention for producing a composite pane 100 according to the invention using a flowchart comprising the steps of:
S1 providing an outer pane 1 having an outer surface I and an interior surface II, a first intermediate layer 3, a hologram element 4 having at least one hologram and an inner pane 2 having an outer surface Ill and an interior surface IV, and an optically highly-refractive layer 6 applied to the interior surface IV.
S2 forming a layer stack in which and the first intermediate layer 3 is arranged between the outer pane 1 and the inner pane 2, and the hologram element 4 is arranged between the outer pane 1 and the first intermediate layer 3 or between the inner pane 2 and the first intermediate layer 3.
S3 joining the layer stack by lamination.

According to the invention, exactly one optically highly-refractive, and preferably transparent, layer is arranged on the interior surface of the inner pane (side IV). This optically highly-refractive layer provided according to the invention advantageously makes it possible to select the angle of inclination of the composite pane in a holographic head-up display projection arrangement more freely, and in particular to shift it towards larger Brewster angles. This means that HUD functions can be implemented even when the composite pane is installed in steeper positions, as is the case in trucks or tractors, for example, and, at the same time, artifacts and ghost images caused by reflected components of the light can be avoided as far as possible.

### List of Reference Signs

100 composite pane
1 outer pane
2 inner pane
3 first intermediate layer
4 hologram element
5 holographic material
6 HI coating (optically highly-refractive layer)
7 second intermediate layer
8 first substrate layer
9 second substrate layer
I outer surface of the outer pane 1
II interior surface of the outer pane 1
III outer surface of the inner pane 2
IV interior surface of the inner pane 2
O upper edge
U lower edge
S side edge
X-X′ line section

1. A composite pane, comprising:
an outer pane having an outer surface and an interior surface,
an inner pane having an outer surface and an interior surface,
a first intermediate layer, and
a hologram element having at least one hologram,
wherein the first intermediate layer is arranged between the outer pane and the inner pane, the hologram element is arranged between the outer pane and the first intermediate layer or between the inner pane and the first intermediate layer,
wherein the composite pane is a vehicle pane,
and wherein an optically highly-refractive layer having a refractive index of greater than or equal to 2 is arranged on the interior surface of the inner pane.

2. The composite pane according to claim 1, wherein the composite pane is a windshield.

3. The composite pane according to claim 1, wherein the optically highly-refractive layer is formed on the basis of silicon nitride, tin-zinc oxide, silicon-zirconium nitride, silicon-titanium nitride, silicon-hafnium nitride, or titanium oxide.

4. The composite pane according to claim 1, wherein the optically highly-refractive layer is formed with a layer thickness of 10 nm to 100 nm.

5. The composite pane according to claim 1, wherein the hologram element comprises a holographic material, and the holographic material is formed as a coating on the interior surface of the outer pane or as a coating on the outer surface of the inner pane.

6. The composite pane according to claim 1, wherein the hologram element is arranged between the first intermediate layer and the inner pane, and the composite pane additionally comprises a second intermediate layer which is arranged between the inner pane and the hologram element.

7. The composite pane according to claim 1, wherein first intermediate layer and/or, if a second intermediate layer is arranged between the inner pane and the hologram element, the second intermediate layer is, independently of one another, a thermoplastic intermediate layer, an adhesive layer, or an optically clear adhesive.

8. The composite pane according to claim 1, wherein the hologram element comprises a holographic material and a first substrate layer and/or a second substrate layer.

9. The composite pane according to claim 1, wherein the hologram element comprises a photopolymer, dichromate gelatin, or silver halide gelatin, as the holographic material.

10. The composite pane according to claim 8, wherein the hologram element comprises a holographic material, a first substrate layer, and a second substrate layer, wherein the first substrate layer is arranged between the holographic material and the first intermediate layer, and the second substrate layer is arranged between the holographic material and the second intermediate layer.

11. The composite pane according to claim 8, wherein the first substrate layer and/or the second substrate layer comprises polyamide, cellulose triacetate, and/or polyethylene terephthalate.

12. A projection arrangement comprising a composite pane according to claim 1 and a projector which is directed from sides of the inner pane onto the hologram element.

13. A method for producing a composite pane according to claim 1, comprising:
a) providing an outer pane having an outer surface and an interior surface, a first intermediate layer, a hologram element having at least one hologram and an inner pane having an outer surface and an interior surface, and a transparent, optically highly-refractive layer applied to the interior surface are provided,
b) forming a layer stack in which the first intermediate layer is arranged between the outer pane and the inner pane, and the hologram element is arranged between the outer pane and the first intermediate layer or between the inner pane and the first intermediate layer, and
c) joining the layer stack by lamination.

14. The method for producing a composite pane according to claim 13, wherein the optically highly-refractive layer is applied to the interior surface of the inner pane by wet coating, by magnetron sputtering, or by chemical or physical vapor deposition methods.

15. A method comprising implementing a composite pane according to claim 1 as a vehicle pane in a locomotion vehicle for traffic on land, in the air, or on water.

16. The composite pane according to claim 3, wherein the optically highly-refractive layer is formed on the basis of silicon-zirconium nitride or titanium oxide.

17. The composite pane according to claim 4, wherein the optically highly-refractive layer is formed with a layer thickness of 20 nm to 80 nm.

18. The composite pane according to claim 17, wherein the optically highly-refractive layer is formed with a layer thickness of 50 nm to 70 nm.

19. The method according to claim 15, wherein the composite pane is a windshield serving as a projection surface for a head-up display.
